(19) United States
(12) Patent Application Publication
(10) Pub. No.: US 2007/0130220 A1
(43) Pub. Date: Jun. 7, 2007

(54) Degraded operation technique for error in shared nothing database management system

(76) Inventors: Tsunehiko Baba, Hachioji (JP); Norihiro Hara, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/347,202

(22) Filed: Feb. 6, 2006

(30) Foreign Application Priority Data
Dec. 2, 2005 (JP) 2005-348918

(51) Int. Cl. G06F 17/30

(52) U.S. Cl. 707/202

(57) ABSTRACT

To realize a degraded operation for equalizing loads on servers to prevent performance from being degraded in a server system having a cluster configuration in which a node in which an error occurs is excluded. The server system includes a plurality of DB servers for dividing a transaction of a database processing for execution, a storage system including a preset data area and a preset log area that are accessed by the server, and a management server for managing the transaction to be allocated to the plurality of DB servers. A data area and a log area used by the DB server with the error among the plurality of DB servers are designated, and the data area accessed by the DB server with the error is recovered in the log area accessed by the server with the error.

### CLAIM OF PRIORITY

The present application claims priority from Japanese application P2005-348918 filed on Dec. 2, 2005, the content of which is hereby incorporated by reference into this application.

### BACKGROUND OF THE INVENTION

This invention relates to a computer system with an error tolerance for constructing a shared nothing database management system (hereinafter, abbreviated as DBMS), in particular, a technique of degrading a configuration to exclude a computer with an error when the error occurs in a program or an operating system of a computer in the DBMS.

In a shared nothing DBMS a DB server for processing a transaction corresponds logically or physically one-on-one with a data area for storing the result of processing. When each computer (node) has a uniform performance, the performance of the DBMS depends on the amount of data area owned by a DB server on the node. Therefore, in order to prevent the deterioration of the performance of the DBMS, the amount of data area owned by the DB server on each node is required to be the same.

The following case will now be considered. When an error occurs in a certain node, a system failover method for allowing another node to take over a DB server on the node in which the error occurs (an error node) and data used by the DB server is applied to the shared nothing DBMS. In this case, when the error occurs in the node on which the DB server is operating, the DB server on the error node (an error DB server) and a data area owned by the error DB server are paired with each other to be taken over by another operating node. Then, a recovery process is performed on the node that has taken over the pair.

In the system failover method, another node takes over the pair of the DB server and the data area in the same configuration as that with the error DB server. Therefore, it is necessary to equally distribute DB servers to the other nodes so as to maximize the performance of the DBMS after the occurrence of an error. Accordingly, it is necessary to design the number of DB servers per node in advance. For example, in the case of a DBMS having N nodes, in order to cope with an error occurring in one node, the number of DB servers to be prepared for one node error is required to be a multiple of (N-1) so that the same number of DB servers is distributed to each of (N-1) nodes in operation.

On the other hand, with the complication and the increase in size of the system, the amount of data handled by the DBMS has recently been increasing. The DBMS uses a cluster configuration to enhance the processing capability. As a platform for constructing a cluster configuration system, a blade server capable of easily including an additional a node required for the cluster configuration system is widely used.

However, since the number of nodes constituting a cluster is variable in the platform that is capable of easily changing the configuration as described above, it is impossible to design in advance the number of DB servers and data areas to be suitable to prevent the DBMS performance from being deteriorated even after a system failover for the occurrence of an error as described above. Therefore, there arises a problem in that the amounts of data area become unequal for nodes after the system failover even in a configuration in which the amount of data area is distributed uniformly to all the nodes during normal operations of all the nodes.

In order to cope with the above-described problem of inequality of the amount of data area per node, there is a method of changing the amount of data area owned by a data server to equalize the amount of data per node in the shared nothing DBMS having the cluster configuration. As an example of the method, a technique described in JP 2005-196602 A can be cited.

JP 2005-196602 A describes the following technique. In a shared nothing DBMS, a data area is physically or logically divided into a plurality of areas so that each of the obtained areas is allocated to each DB server. In this manner, the amount of data area for each of the DB servers can be changed so as to prevent the DBMS performance from deteriorating when a total number of DB servers or the number of DB servers per node increases or decreases. In the above-described technique, however, the allocation of all the data areas to the DB servers is changed. In order to ensure data area consistency, it is necessary to ensure the state where the DBMS does not execute a transaction processing. Specifically, in order to effect a configuration change according to the above-described technique, it is necessary to wait for the completion of a task.

### SUMMARY OF THE INVENTION

In the shared nothing DBMS having the cluster configuration as described above, in order to cope with the problem of inequality of the amount of data handled by each node or a throughput for each node after a system failover for the occurrence of a node error, the configuration change using the technique described in the above-mentioned JP 2005-196602 A is effected after the system failover for allowing another node to take over the DB server and its data area. In this manner, the cluster configuration that can prevent the DBMS performance from deteriorating can be realized. In this case, however, a task is stopped twice for the system failover and the configuration change.

Moreover, at the occurrence of a node error, when a configuration change is to be effected using the technique described in JP 2005-196602 A instead of the system failover, all the transactions in operation are required to have been completed. Therefore, when a degraded operation is to be realized at the occurrence of an error, it is necessary to wait for the termination of a transaction that has no relation with a process executed by an error DB server. Accordingly, a longer time is disadvantageously needed to start the degraded operation as compared with the system failover method of allowing another node to immediately take over an error DB server.

This invention has been made in view of the above-described problems, and it is therefore an object of this invention to realize a degraded operation capable of equalizing a load for each server to prevent performance deterioration in a server system having a cluster configuration in which a node in which an error occurs is excluded.

According to an embodiment of this invention, there is provided a server error recovery method used in a database system including: a plurality of servers for dividing a transaction of a database processing for execution; a storage system including a preset data area and a preset log area that are accessed by the servers; and a management server for managing the divided transactions allocated to the plurality of servers, the server error recovery method allowing a normal one of the servers without any error to take over the transaction when an error occurs in any one of the plurality of servers. According to the method, the server in which the error occurs, among the plurality of servers is designated; the data area and the log area that are used by the server with the error in the storage system are designated; a process of another one of the servers executing a transaction related to a process executed in the server with the error is aborted; the data area accessed by the server with the error is assigned to another normal one of the servers; the log area accessed by the server with the error is shared by the server to which the data area of the server with the error is allocated; and the server, to which the data area accessed by the server with the error is allocated, recovers the data area based on the shared log area up to a point of the abort of the process.

Therefore, according to an embodiment of this invention, when an error occurs in any one of the plurality of servers, the data area of the error server is allocated to another one of the servers in operation and the logs of the error server are shared, instead of forming a pair of the error server and its data area to be taken over by another node. Then, a recovery process of the transaction being executed is performed in the server to which the data area is allocated. As a result, each of the servers having a cluster configuration in which the error server can have a uniform load, thereby realizing the degraded operation to prevent deterioration of performance.

### BRIEF DESCRIPTION OF THE DRAWINGS

FIG. 1 is a block diagram showing a computer system to which this invention is applied.

FIG. 2 is a system block diagram mainly showing software according to a first embodiment of this invention.

FIG. 3 is a flowchart showing an example of a process of a cost calculation for a degraded operation and decision of a recovery method executed in a cluster management program at the occurrence of an error.

FIG. 4 is a flowchart showing an example of a process of obtaining information required for the cluster management program to perform the cost calculation of the degraded operation from a DBMS.

FIG. 5 is a flowchart showing an example of a process of creating split transactions, executed in a database management server.

FIG. 6 is a flowchart showing an example of a process of aggregating the split transactions, executed in a database management server.

FIG. 7 is a flowchart showing an example of a process of aborting the split transaction executed in an error DB server and a related split transaction when an error occurs in the DB server.

FIG. 8 is a flowchart showing an example of the process of aborting the split transaction executed in the DB server.

FIG. 9 is a flowchart showing an example of a process of allocating a data area to a DB server in operation, executed in the database management server.

FIG. 10 is a flowchart showing the process of the DB server of allocating a data area in response to a direction of the database management server.

FIG. 11 is a flowchart of a recovery process of the data area, executed in the database management server.

FIG. 12 is a flowchart of the recovery process of the data area, executed in the DB server.

FIG. 13 is a system block diagram mainly showing software according to a modified example of FIG. 2.

FIG. 14 a flowchart showing a second embodiment, illustrating an example of a process of aborting the split transaction executed in an error DB server and a related split transaction when an error occurs in the DB server.

FIG. 15 is a flowchart similarly showing the second embodiment, illustrating an example of a process of allocating a data area to a DB server in operation.

FIG. 16 is a flowchart similarly showing the second embodiment, illustrating an example of a recovery process of a data area, executed in the database management server.

FIG. 17 is a flowchart similarly showing the second embodiment, illustrating an example of the recovery process of the data area, executed in the DB server.

### DETAILED DESCRIPTION OF THE PREFERRED EMBODIMENTS

Hereinafter, a first embodiment of this invention will be described with reference to the accompanying drawings.

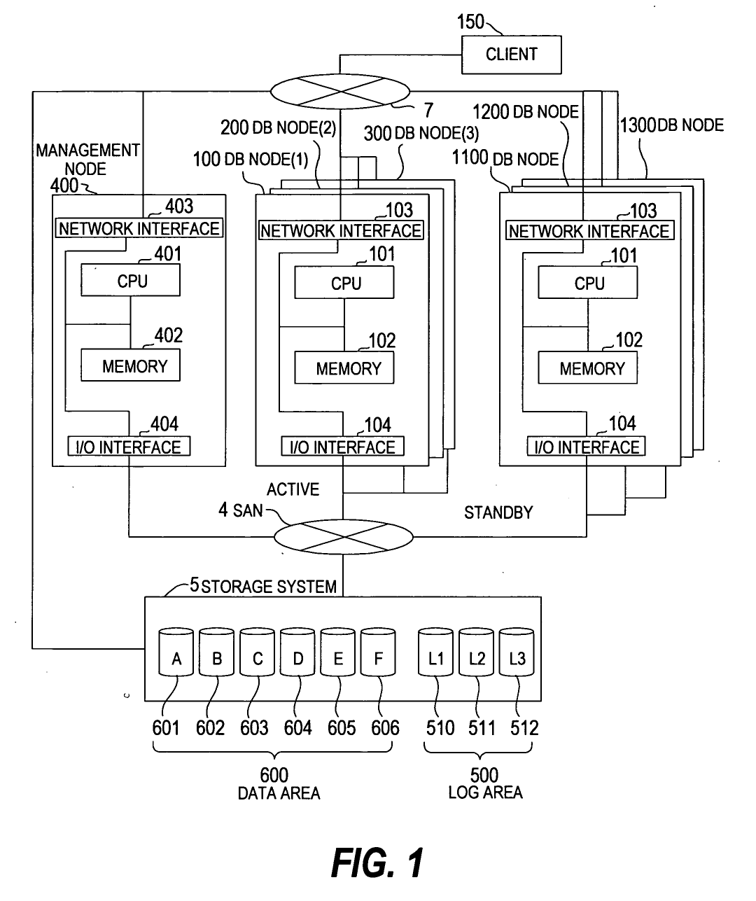

FIG. 1 is a block diagram showing the first embodiment, illustrating a hardware configuration of a computer system to which this invention is applied.

In FIG. 1, an active computer group, a management node (server) 400, a standby computer group, and a client computer 150 are connected to a network 7. The active computer group is composed of a plurality of database nodes (hereinafter, referred to simply as DB nodes) 100, 200, and 300 that have a cluster configuration to provide a database task. The management node 400 executes a database management system and a cluster management program for managing the DB nodes 100 through 300. The standby computer group is composed of a plurality of DB nodes 1100, 1200, and 1300 that take over a task of a node in which an error occurs (hereinafter, referred to as an error node) when an error occurs in any of the active DB nodes 100 through 300. The client computer 150 uses a database from the DB nodes 100 through 300 through the management node 400. The network 7 is realized by, for example, an IP network.

The management node 400 includes a CPU 401 for performing an arithmetic processing, a memory 402 for storing a program and data, a network interface 403 for communicating other computers through the network 7, and an I/O interface (such as a host bus adapter) 404 for accessing a storage system 5 through a SAN (Storage Area Network) 4.

The DB node 100 is composed of a plurality of computers. This embodiment shows the example where the DB node 100 is composed of three computers. The DB node 100 includes a CPU 101 for performing an arithmetic processing, a memory 102 for storing a program and data for a database processing, a network interface 103 for communicating with other computers through the network 7, and an I/O interface 104 for accessing a storage system 5 through the SAN 4. Each of the DB nodes 200 and 300 is configured in the same manner as the DB node 100. The standby DB nodes 1100 through 1300 are the same as the active DB nodes 100 through 300 described above.

The storage system 5 includes a plurality of disk drives. As storage areas accessible from the active DB nodes 100 through 300, the management node 400, and the standby nodes 1100 through 1300, areas (such as logical or physical volumes) 510 through 512 and 601 through 606 are set. Among the areas, the areas 510 through 512 are used as a log area 500 for storing logs of databases of the respective DB nodes 100 through 300, while the areas 601 through 606 are used as a data area 600 for storing databases allocated to the respective DB nodes 100 through 300.

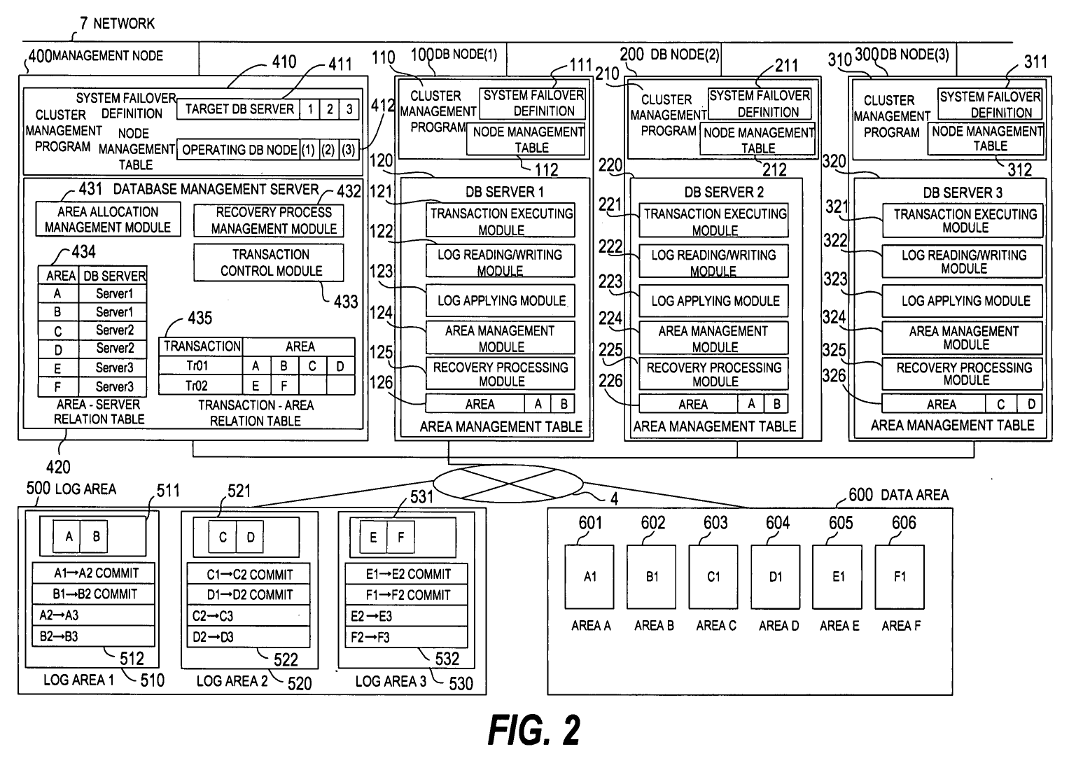

FIG. 2 is functional block diagram mainly showing software when this invention is applied to the database system having the cluster configuration.

In FIG. 2, in the database system, the database management server 420 operating on the management node 400 receives a query from the client 150 to distribute a database processing (a transaction) to the DB servers 120, 220, and 320 operating on the respective DB nodes 100 through 300. After aggregating the results from the DB servers 120 through 320, the database management server 420 returns the result of the query to the client 150.

The data area 600 and the log area 500 in the storage system 5 are allocated respectively to the DB servers 120 through 320. The DB servers 120 through 320 configure a so-called shared nothing database management system (DBMS), which occupies the allocated areas to execute a database processing. The management node 400 executes a cluster management program (cluster management module) 410 for managing each of the DB nodes 100 through 300 and the cluster configuration.

First, the DB node 100 includes a cluster management program 110 for monitoring an operating state of each of the DB nodes and the DB server 120 for processing a transaction under the control of the database management server (hereinafter, referred to as the DB management server) 420.

The cluster management program 110 includes a system failover definition 111 for defining a system failover destination to take over a DB server included in a DB node when an error occurs in the DB node and a node management table 112 for managing operating states of the other nodes constituting the cluster. The system failover definition 111 may explicitly describe a node to be a system failover destination or may describe a method of uniquely determining a node to be a system failover destination. The operating states of the other nodes managed by the node management table 112 may be monitored through communication with cluster management programs of the other nodes.

Next, the DB server 120 includes a transaction executing module 121 for executing a transaction, a log reading/writing module 122 for writing an execution state (update history) of the transaction, a log applying module 123 for updating data based on the execution state of the transaction, which is written by the log reading/writing module 122, an area management module 124 for storing a data area into which data is to be written by the log applying module 123, and a recovery processing module 125 for reading a log by using the log reading/writing module 122 when an error occurs to perform a data updating process using the log applying module 123 so as to keep data consistency on the data area described in the area management module 124. The DB server 120 includes an area management table 126 for keeping an allocated data area. The DB nodes 200 and 300 similarly execute DB servers 220 and 320 for performing a process under the control of the database management server 420 of the management node 400 and cluster management programs 210 and 310 for mutually monitoring the DB nodes. Components of each of the DB nodes 100 through 300 are denoted so that the components of the DB node 100 are denoted by the reference numerals from 100 to 199, those of the DB node 200 are denoted by the reference numerals 200 to 299, and those of the DB node 300 are denoted by the reference numerals 300 to 399 in FIG. 2.

Next, the management node 400 includes a cluster management program 410 having the same configuration as that of the cluster management program 100 and the DB management server 420. The DB management server 420 includes an area allocation management module 431 for relating the DB servers 120 through 320 to the data area 600 allocated thereto, a transaction control module 433 for executing an externally input transaction in each of the DB servers to return the result of execution to the exterior, a recovery process management module 432 for directing each of the DB servers to perform a recovery process when an error occurs in any of the DB nodes 100 through 300, an area-server relation table 434 for relating each of the DB servers to a data area allocated thereto, and a transaction-area relation table 435 for showing to which data area a transaction externally transmitted to the DB management server 420 is addressed.

The area allocation management module 431 stores the relations of the DB servers 120 to 320 and the data area 600 allocated thereto in the area-server relation table 434. Next, the DB management server 420 splits the externally transmitted transaction into split transactions, each corresponding to a processing unit for each data area. After storing the relations between the split transactions obtained by dividing the transaction according to the data areas and the data areas executing the split transactions in the transaction-area relation table 435, the DB management server 420 inputs the split transactions to the DB servers having the data areas to be processed based on the relations in the area-server relation table 434.

The DB management server 420 receives the result of processing of the input split transaction from each of the DB servers 120 to 320. After receiving all the split transactions, the DB management server 420 aggregates the results of the received slit transactions to obtain the result of the original transaction based on the relation table 435 and returns the obtained result to the source of the transaction. Thereafter, the DB management server 420 deletes an entry of the transaction from the relation table 435.

Furthermore, the data area 600 in the storage system 5 is composed of a plurality of areas A 601through F 606, each corresponding to an allocation unit to each of the DB servers 100 through 300. The log area 500 includes log areas 510, 520, and 530 respectively provided for the DB servers 120 to 320 in the storage system 5. The log areas 510, 520, and 530 respectively include the contents of the change 512, 522, and 532 including the presence/absence of a commit by the DB servers 100 through 300 including the log areas to the data area 600 and the logs 511, 521, and 531 describing the transactions causing the changes.

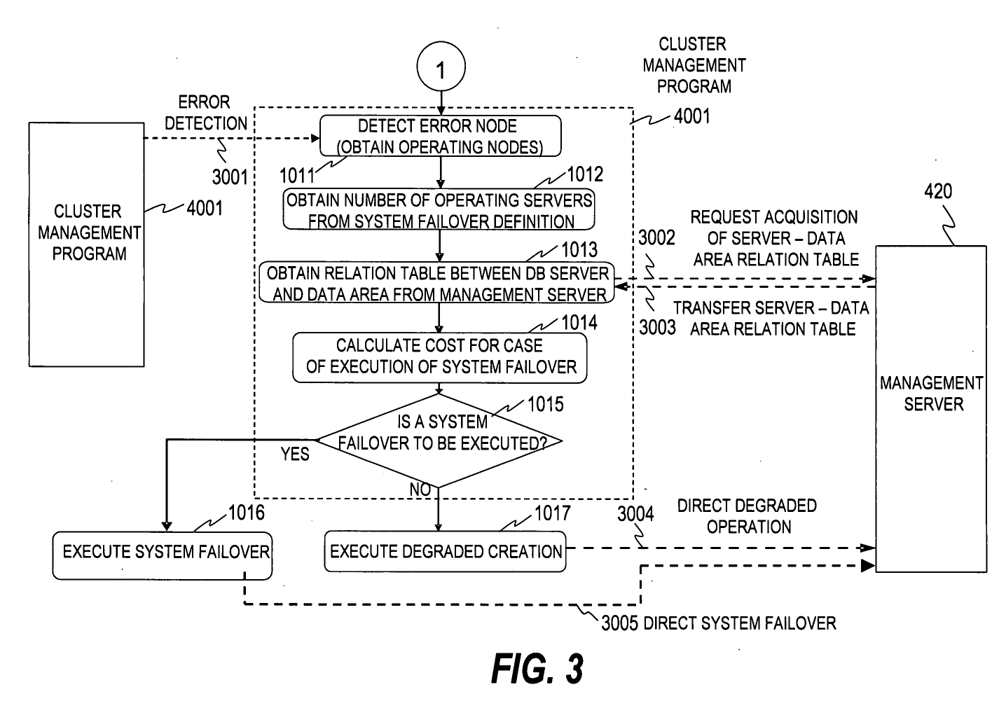

FIGS. 3 through 15 are flowcharts showing a cluster management program at each node and operations of the DB management server and the DB servers in this embodiment.

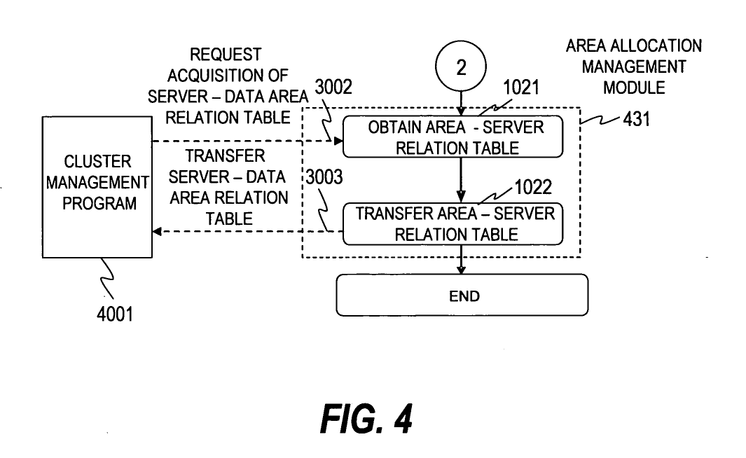

First, in FIGS. 3 and 4, when an error occurs at any one of the DB nodes 100 through 300, a system failover process of allowing another node to take over the DB servers 120 through 320 on the DB nodes, in which the error occurs, and a degraded operation process (reduction of the number of operating DB servers) of allowing the DB server on another node to take over the data area used by the DB server with the error are selected. FIGS. 3 and 4 are flowcharts showing the above processes.

In FIG. 3, a cluster management program 4001 at one node monitors a cluster management program 4001 at another node to detect an error occurring at the latter node (notification 3001). The cluster management program 4001 in FIGS. 3 and 4 designates any one of the cluster management programs 110, 210, 310, and 410 of the DB nodes 100 through 300 and the management node 400. Similarly, the cluster management program 4001 in FIGS. 3 and 4 designates any one of the other cluster management programs 110 through 410. Hereinafter, the case of the cluster management program 110 of the DB node 100 will be described as an example.

Based on the notification (error detection) 3001, the cluster management program 4001 detects an error occurring at another node and keeps operating nodes and the error node in the node management table 112 (process 1011). After the process 1011, the cluster management program 4001 uses the system failover definition 111 to obtain the number of DB servers operating on each of the nodes including the error node (process 1012). Subsequently, in process 1013, the cluster management program 4001 requests the DB management server 420 to obtain the area-server relation table 434 (notification 3002), thereby obtaining the area-server relation table 434 (notification 3003). As shown in FIG. 1, the area-server relation table 434 indicates that the data areas A and B (601 and 602) are allocated to the DB server 120, the data areas C and D (603 and 604) to the DB server 220, and the data areas E and F (605 and 606) to the DB server 320.

In FIG. 4, the area allocation management module 431 on the DB management server 420 receiving the notification (acquisition request) 3002 reads the area-server relation table 434 (process 1021) to transfer the relation table 434 to the cluster management program 4001 corresponding to a request source (process 1022 and notification 3003). Subsequently, in process 1014 in FIG. 3, the cluster management program 4001 calculates costs for the case where the system failover is performed and for the case where the degradation is performed.

The cost calculation allows calculation of the amount of data area for each DB node after the system failover or the degradation by any one of the following methods when, for example, attention is focused on the performance of the DB nodes (for example, a throughput, a transaction processing capability, or the like). Specifically, it is possible to use a calculation method of determining whether the number of DB servers on the error node is divisible by the number of operating nodes detected in the process 1011 based on the number of DB servers obtained in the process 1012 or a calculation method of using the relation table 434 obtained in the process 1013 to determine if the data areas used by the DB servers on the error node are evenly divisible by the number of DB serves on the operating nodes.

Alternatively, in the cost calculation, a load factor of the DB servers 120 through 320 on the DB nodes 100 through 300 (for example, a load factor of the CPU) may be obtained.

Further alternatively, it is possible to use a method of explicitly directing the cluster management program 4001 by the user to use which of the system failover and the system degrading or a method of designating the amount of load (the amount of data areas or the amount of transaction processing per DB node) on the DB server allowed to stop a task for the degradation, to select any one of the degradation and the system failover based on the amount of load on the DB server at the occurrence of the error. In addition, a method obtained by weighting and combining the above methods may also be used.

It is judged whether or not to execute the system failover based on the result of the cost calculation in the process 1014 (process 1015). When the system failover is to be executed, the system failover process is executed (process 1016). Otherwise, the degraded operation is executed (process 1017).

For example, when high-speed recovery from an error is to be achieved so as to reduce a stop time for the error, the degraded operation is selected. On the other hand, when the deterioration of the processing capability of the DBMS due to the takeover of the DB servers is not allowed because of the reasons such as a low hardware performance of the DB nodes and therefore it is necessary to keep deterioration of the DBMS performance at minimum, the system failover can be selected.

Alternatively, when the number of the DB servers on the error DB node is divisible by the number of operating DB nodes detected in the process 1011, the degradation is selected. Otherwise, the system failover is selected. Further alternatively, when a result of the cost calculation indicates that the amount of load in the case where the degradation is performed exceeds a preset threshold value, the system failover may be selected. If the amount of load is equal to or below the threshold value, the degradation may be selected.

When the processing load (for example, the load factor of the CPU) is obtained as the above-described cost, any one of the degradation and the system failover which allows the processing loads (for example, CPU load factors) to be equal for all the normal DB nodes 100 through 300 (in other words, which provides a small variation in processing load) may be selected. In particular, when the DB nodes 100 through 300 have a difference in processing capability, in other words, the DB nodes 100 through 300 have a difference in hardware structure, any one of the degradation and the system failover may be selected so as to provide a smaller variation in CPU load factor.

In the processes 1016 and 1017, the DB management server is notified of the execution of the system failover process and the degraded operation process, respectively (notification 3004 and notification 3005). In the notification 3004 (the direction of the degraded operation to the database management server 420), the DB management server may be notified of the error DB server or the error node.

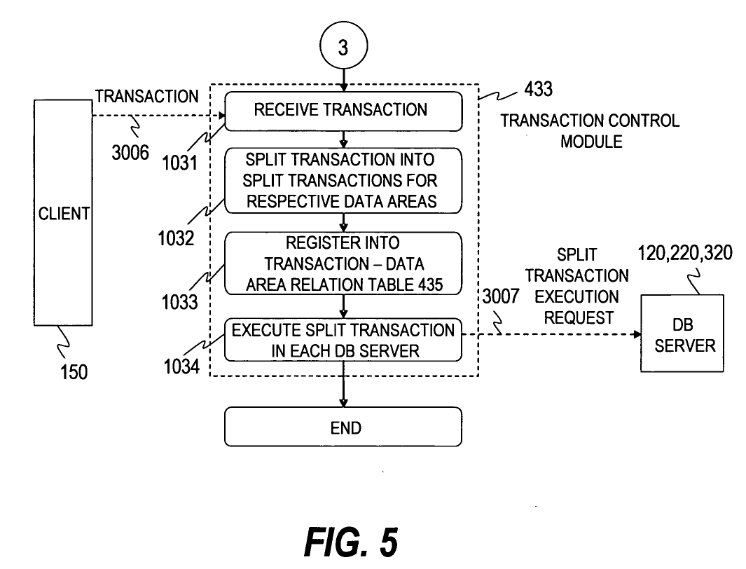

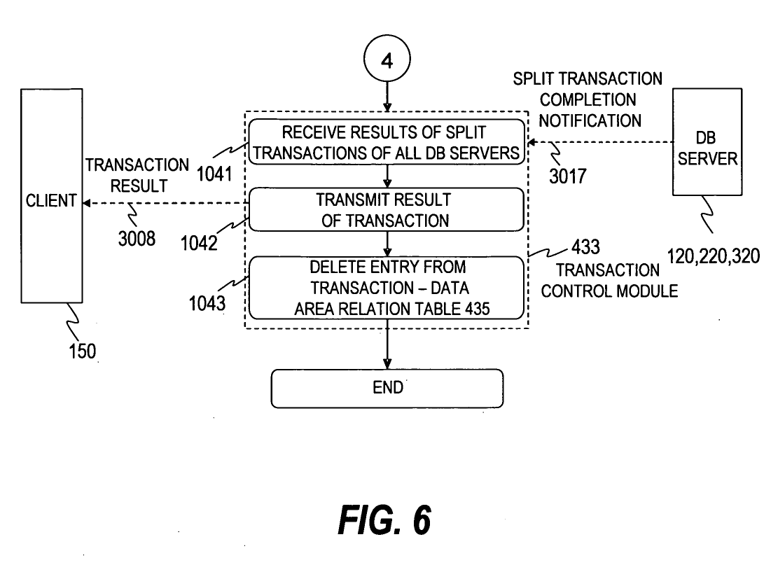

FIGS. 5 and 6 are flowcharts showing a process, in which the DB management server 420 that has received the transaction from the exterior (the client 150) controls each of the DB servers 120 through 320 to execute a process and then returns the result of processing to a request source. The transaction means a data operation request group having dependency. Therefore, when the transactions differ from one another, data to be operated do not have dependency and therefore can be processed independently.

In FIG. 5, upon reception of the transaction (notification (a transaction request) 3006) from the client 150 (process 1031), the transaction control module 433 on the DB management server 420 splits the transaction 3005 into split transactions respectively corresponding to processes for the areas A 601 through F 606 in the data area 600 managed by the DB management server 420 (process 1032). Thereafter, the transaction control module 433 relates each of the areas, to which each of the split transactions obtained by the process 1032 corresponds, and the transaction 3005 to each other and registers them in the transaction-area relation table 435 (process 1033). Based on the area-server relation table 434, the split transactions are executed on the corresponding DB servers 120 through 320, respectively (process 1034 and notification (a split transaction execution request) 3007).

After the result of execution of the split transactions executed on the respective DB servers 120 through 320 notified by a split transaction completion notification 3017 in FIG. 6 is received again by the transaction control module 433 (process 1041 and the notification 3017), the result is transmitted to the client 150 corresponding to a transmission source (process 1042 and notification 3008). Since the execution of the transaction 3005 is completed by the process 1042, an entry of the transaction 3005 is deleted from the transaction-area relation table 435.

As described above, by the processes shown in FIGS. 5 and 6, the DB management server 420 has the relation tables 434 and 435 for determining which data area is executed on which DB server for the transaction from the client 150. The DB management server 420 splits the transaction into the split transactions and requests each of the DB servers 120 through 320 to process each of the split transactions. The DB servers 120 through 320 execute the split transactions in parallel to return the results of execution to the DB management server 420. After combining the received results of execution based on the relation tables 434 and 435, the DB management server 420 returns the obtained result to the client 150.

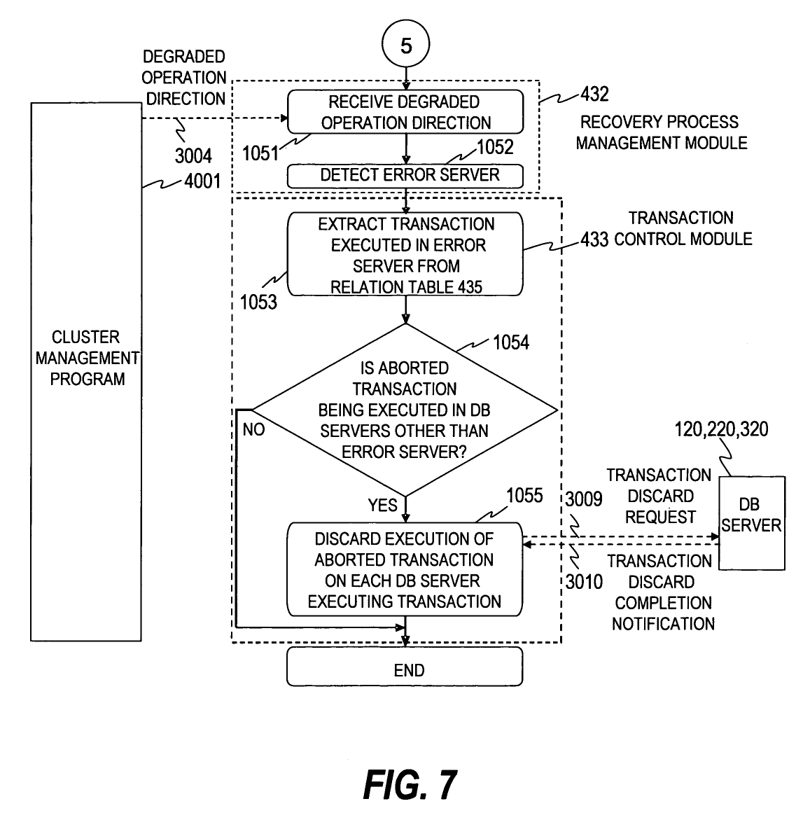

FIGS. 7 to 12 are flowcharts showing the following process. After the data area owned by the DB node, in which an error occurs, is allocated to the DB server on another operating DB node so as to execute a recovery process, the DB server, to which the data areas is allocated, continues the process to degrade the error node.

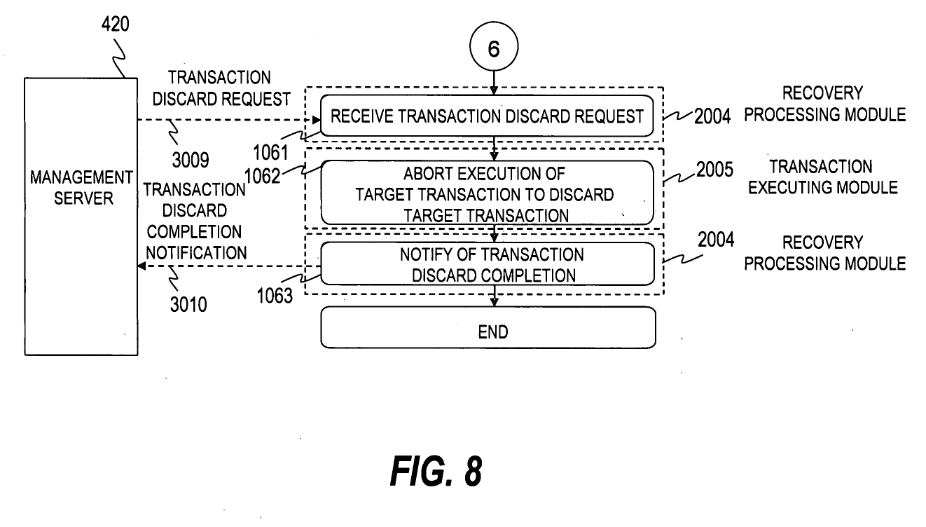

FIGS. 7 and 8 are flowcharts of a process, in which the DB management server 420 judges, upon reception of a direction to carry out the degraded operation from the cluster management program 4001, whether or not a transaction related to a process being executed in the error DB server is executed on another node to direct each of the DB servers executing the process to stop the process, and the process stopped by each of the DB servers. A transaction executing module 2005 described below designates the transaction execution modules 121 through 321 in the DB servers 120 through 320.

In FIG. 7, upon reception of a notification (a degraded operation direction) 3004 to carry out the degraded operation from the cluster management program 4001 (process 1051), a recovery process management module 432 of the DB management server 420 detects an error DB server based on the notification 3004 (process 1052). In the process 1052, when the notification 3004 contains information on the error DB server, the error DB server can be detected by using the error information.

When the notification 3004 does not contain the information on the error DB server, the error DB server can be detected by querying the DB management server 420 or the cluster management program 4001. After the execution of the error detection process 1052, the transaction control module 433 of the DB management server 420 refers to the transaction-area relation table 435 to extract the transaction related to the process executed in the error DB server detected in the process 1052 (process 1053). Then, the transaction control module 433 judges whether or not the split transaction created from the transaction aborted by the error in the process 1032 is being executed in the DB server other than the error DB server (process 1054).

When the corresponding split transaction is being executed in the DB server other than the error DB server in the process 1054, the area-server relation table 434 is used to notify each of the DB servers executing the split transaction to discard the transaction (notification 3009). The DB server control module 433 receives a split transaction discard completion notification 3010 (process 1055).

In FIG. 8, the recovery processing module 2004 and the transaction executing module 2005 of the DB servers 120 through 320 receive the discard request notification 3010 (process 1061) to abort the execution of the target split transactions (process 1062). The DB servers 120 through 320 transmit a split transaction abort completion notification 3011 to the DB management server 420 (process 1063). On the other hand, when there is no corresponding DB server in the process 1054 in FIG. 7, the process is terminated. The recovery processing module 2004 designates the recovery processing modules 125, 225, and 325 of the DB servers 120 through 320 in FIG. 2.

Through the above process, the DB management server 420 plays a central part in aborting all the processes of the transaction related to the process executed in the error DB server to allow a recovery process described below to be executed.

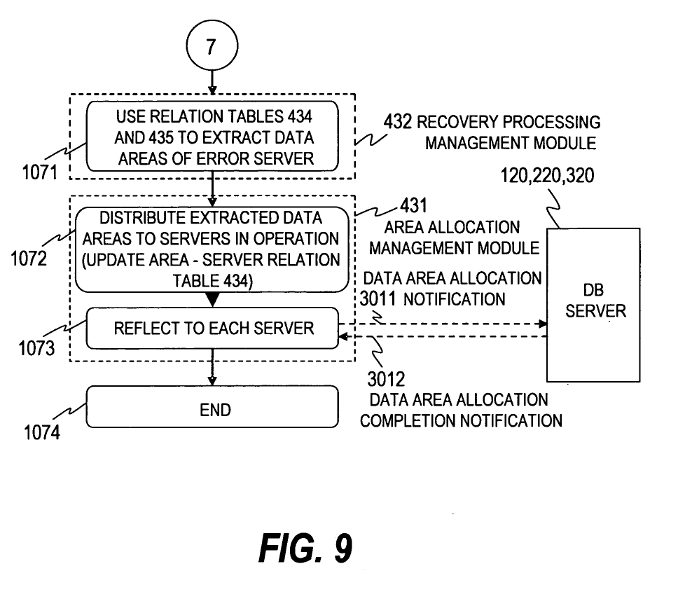

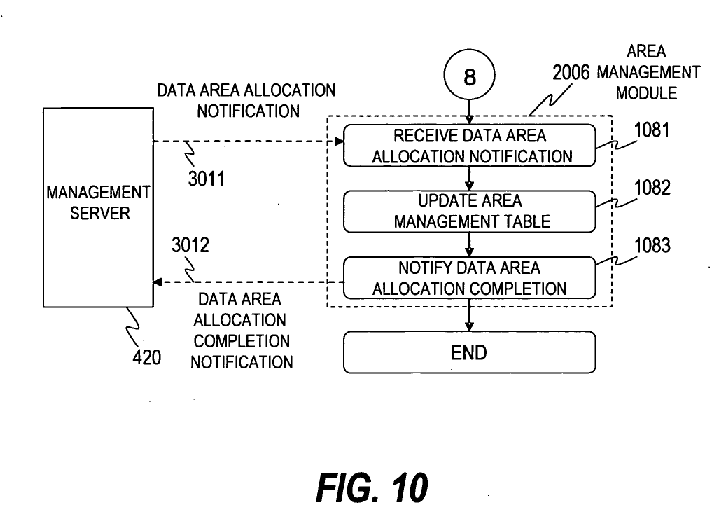

FIGS. 9 and 10 are flowcharts showing a process of allocating the data areas in the error DB server to the DB server operating on another node.

In FIG. 9, the recovery process management module 432 of the DB management server 420 refers to the area-server relation table 434 and the transaction-area relation table 435 to extract the data area in the error DB server (process 1071). Then, the relation table 434 is updated so as to allocate the data area extracted by the recovery process management module 432 to the operating DB servers 120 through 320 (process 1072). Then, the DB management server 420 notifies each DB server to execute the allocation of the data areas updated in the relation table 434 (notification (an area allocation notification) 3011). The DB management server 420 receives a completion notification 3012 indicating the termination of mounting of the data areas from the DB servers 120 to 320 that have directed to execute the allocation (process 1073). As the notification 3012, the relation table 434 may be transmitted.

Through the above process, the DB management server 420 distributes the data areas allocated to the error DB server to the normally operating DB servers 120 through 320.

FIG. 10 shows a process in the area management modules 124 to 324 in the respective DB servers 120 to 320. In FIG. 10, an area management module 2006 designates the area management modules 124 to 324 of the respective DB servers 120 to 320.

The area management module 2006 receives the notification (the area allocation notification) 3011 (process 1081) to update the area management tables 126, 226, and 326 of the respective DB servers 120 to 320 (process 1082) as updated in the area-server relation table 434. After the completion of the update, the area management module 2006 notifies the DB management server 420 of the completion (process 1083 and notification 3012).

When the transaction abort request executed in FIGS. 7 and 8 is followed by the execution of the processes in FIGS. 9 and 10 described above, the data areas included in the error DB server are passed to the normally operating DB servers.

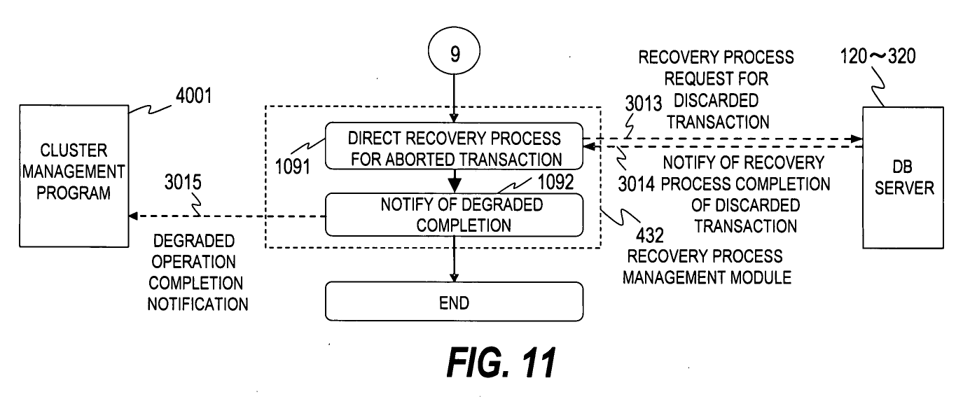

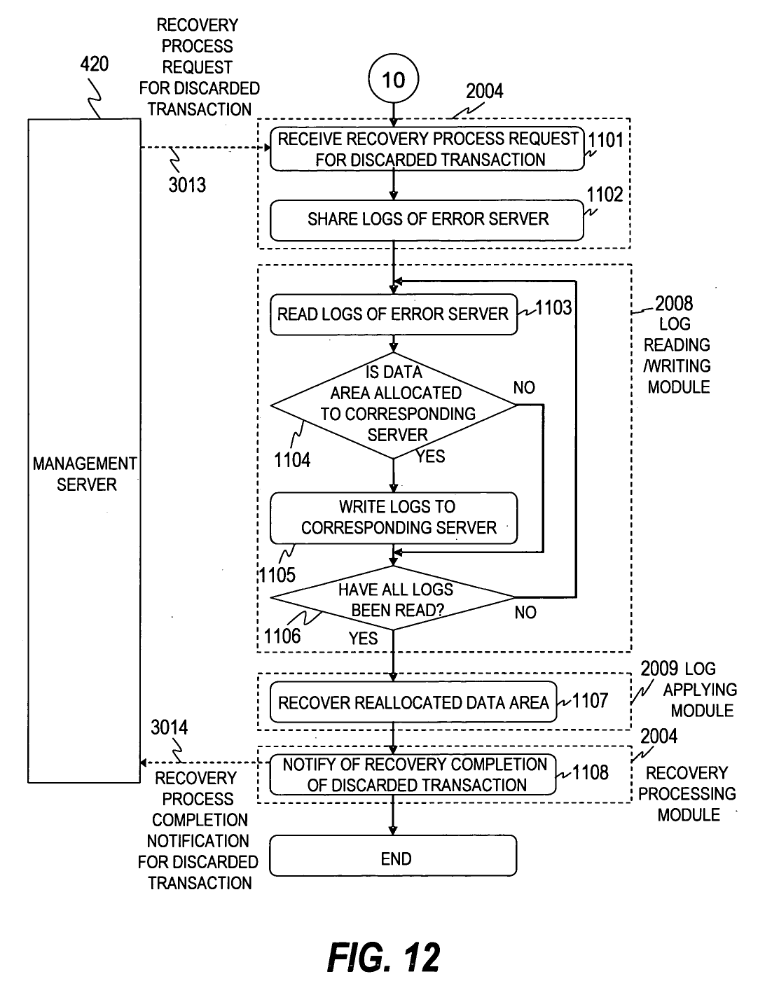

FIGS. 11 and 12 are flowcharts showing a process, which is executed after the processes shown in FIGS. 9 and 10, of recovering the data areas processed by the split transactions aborted by the split transaction abort request in the discard completion notification 3010 and the error.

In FIG. 11, the recovery process management module 432 of the DB management server 420 notifies the DB servers 120 to 320 of a discarded (aborted) transaction recovery process request so as to recover the data areas executing the transaction aborted by the error and the completion notification 3010 based on the area-server relation table 434 and the transaction-area relation table 435 (notification 3013), and then receives a completion notification 3014 of the recovery process request from the DB servers 120 to 320 (process 1091). After the completion of the process 1091, the aborted transaction is deleted from the transaction-area relation table 435. Then, the recovery process management module 432 transmits notification 3015 indicating the completion of the degradation to the cluster management program 4001 (process 1092).

Through the above process, the recovery of the data areas, in which inconsistency is caused by the transaction aborted by the occurrence of the error, is completed to complete a change to the cluster configuration from which the error node is excluded. Thus, the degradation is completed.

FIG. 12 shows a process in each of the recovery process modules 125, 225, and 325 of the respective DB servers 120 to 320. In FIG. 12, the log reading/writing modules 122, 222, and 322 of the respective DB servers 120 to 320 are collectively referred to as a “log reading/writing module 2008”.

The recovery processing module 2007 of each of the DB servers 120 to 320 receives the notification 3013 (process 1101) to share the logs owned by the error DB server so as to recover the data area owned by the error DB server (process 1102). Subsequently, the log reading/writing module 2008 reads the logs from the log area 500 shared by the process 1102 (process 1103).

It is judged whether or not the logs read in the process 1103 are for the data area owned by the error DB server, which is allocated to the DB server (hereinafter, the DB server, to which the data area owned by the error DB server is allocated, is referred to as the “corresponding DB server”) (process 1104). When the data area in the error DB server is allocated to the corresponding DB server in the process 1104, the logs are written to the log area of the corresponding DB server (process 1105). Then, process 1106 is executed. On the other hand, when the data area is not allocated to the corresponding DB server in the process 1104, the process 1106 is executed.

In the process 1106, it is judged whether or not all the logs shared in the process 1102 have been read (process 1106). Otherwise, the process returns to the process 1103. Otherwise, process 1107 is executed in a log applying module 2009 to apply the read logs so as to recover the data passed from the error DB server in the data area allocated to the corresponding DB server. The log applying module 2009 designates the log applying modules 123, 223, and 323 of the respective DB servers 120 to 320.

Through the above processes 1103 to 1106, in the DB server, to which the data area owned by the error DB server is allocated, only the logs related to the allocated data area are extracted from the logs owned by the error DB server so as to complete the writing of the extracted logs in the log area of the corresponding server. Thus, in the log area owned by the corresponding DB server, all the logs related to the data area owned by the corresponding DB server are written. Therefore, the process of recovering the data area related to the transaction aborted by the node error can be executed (process 1107). After the completion of the recovery of the data area owned by the corresponding DB server by the process 1107, the recovery processing modules 125, 225, and 325 of the respective DB servers 120 to 320 notify the management server 420 of the completion notification 3014 (process 1108).

Although the processes 1102 through 1106 have been performed in all the DB servers for the simplification of the description, the processes may be selectively executed only in the DB server, to which the data area owned by the error DB server is allocated. Similarly, the process 1107 may also be selectively executed only in the DB server, to which the data area owned by the error DB server is allocated, and the DB server whose process is aborted by the notification 3010.

By performing the above-described processes shown in FIGS. 7 through 12, the data area owned by the error DB server is passed to the DB server in operation after the inconsistency in the data area caused by the error is recovered, thereby realizing the degraded operation.

In FIG. 2, the DBMS, in which the area allocation management module 431, the recovery process management module 432, and the transaction control module 433 of the DB management server 420 function as one server to be provided on a node different from the DB nodes 100 through 300, has been described as an example. However, each of the modules may function as an independent server to be provided on a different node or may be located on the same node as the DB nodes 100 to 300. In this case, when information is exchanged between other servers or other nodes, the process described in the first embodiment can be realized by performing communication therebetween.

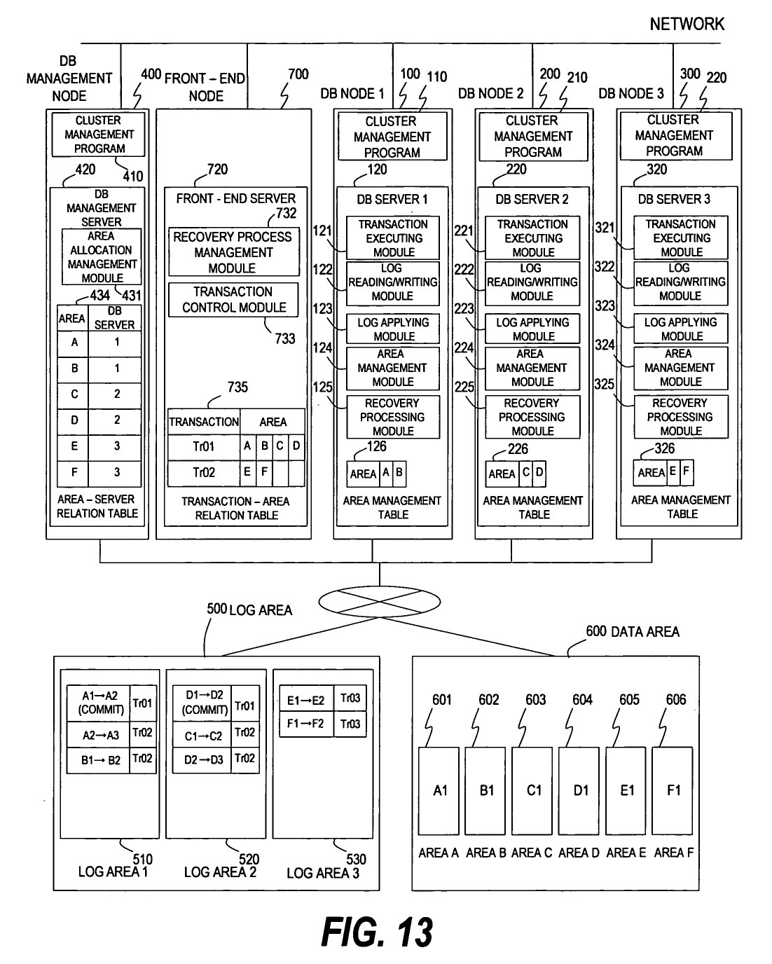

For example, as a variation of the embodiment of this invention, as shown in FIG. 13, the transaction control module 422, the transaction-area relation table 435, and the recovery process management module 432 for executing the recovery process of the data area at the time of degradation may constitute a front-end server 720, which is independent of the DB management server 420, to provide a front-end node 700 independent of the DB management nodes 100 to 300.

Although the data area in the shared nothing DBMS is used to calculate the amount of load serving as an index of selecting any one of the system failover and the degraded operation in the above-described processes 1012 to 1014, other cluster applications allowing the server to perform the system failover and the degraded operation, for example, a WEB application can also be used. When this invention is applied to such the cluster application, not the amount of data area that determines the amount of load in the DBMS but the amount of data determining the amount of load on the application may be used. For example, in the case of the WEB application, the amount of connected transactions may be used.

As described above, according to the first embodiment, when an error occurs in a certain node (a DB node or a DB server) in the shared nothing DBMS (the database management server 420 and each of the DB servers 120 to 320) having a cluster configuration, the system failover and the degraded operation can be selectively executed based on the requirements of a user.

Furthermore, when the degraded operation is executed, the process of the DB server at another node, which executed a transaction related to the process executed in the DB server at an error node, is aborted to allocate the data area owned by the DB server at the error node to the DB server at another node so that the log area owned by the error DB server is shared by the DB server to take over the log area. As a result, the recovery process of the transaction related to the process executed in the error node can be executed in all the data areas including the data area owned by the error DB server.

By the above operation, in the first embodiment, when an error occurs in a node in the shared nothing DBMS, the degradation to the cluster configuration excluding the error node can be realized without stopping the processes of all the DB servers. Therefore, a high-availability shared nothing DBMS, which realizes at a high speed a cluster configuration for preventing the deterioration of the DBMS performance caused by the degraded operation, can be provided.

### Second Embodiment

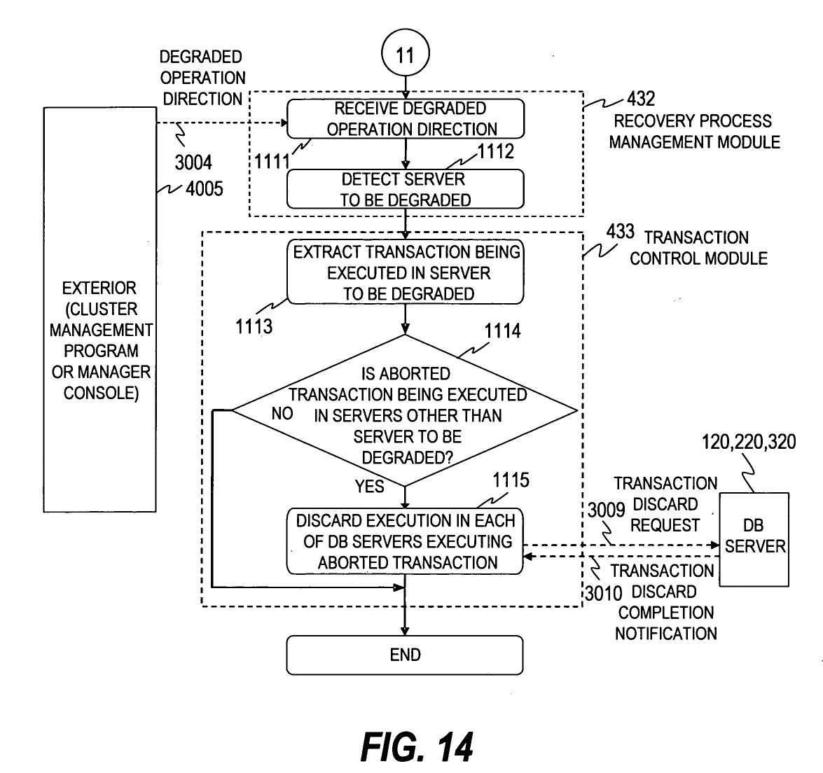

FIGS. 14 through 17 are flowcharts showing a second embodiment, which replace the flowcharts described in the first embodiment to represent a new process. In this second embodiment, the processes in FIGS. 7, 9, 11, and 12 of the first embodiment are replaced by those of FIGS. 14 to 17. The other processes are the same as those of the first embodiment.

First, upon a direction of the degraded operation transmitted from the cluster management program at an arbitrary time point, a transaction related to the process being executed by the DB server to be degraded is aborted. Then, after the allocation of the data area owned by the DB server to be degraded to another DB server in operation, a recovery process of the data areas having inconsistency caused by the aborted transaction is performed. Furthermore, the aborted transaction is re-executed based on the allocation of the data areas after the configuration change. Through the above process, at an arbitrary time point other than the time of occurrence of a node error, the DBMS degradation can be realized.

Hereinafter, a difference of the processes shown in FIGS. 14 through 17 replacing the process of the first embodiment will be described.

First, FIG. 14 replaces FIG. 7 of the first embodiment. By the cooperation with FIG. 8 of the first embodiment, the recovery process management module 432 receives a direction of the degraded operation at an arbitrary time point from an exterior 4005 such as the cluster management program 4001, a management console (not shown), or the like (notification 3002) (process 1111). Upon reception of the direction, the degraded operation is performed. Processes 1112 through 1115 correspond to the processes 1052 to 1055. A process is performed for the DB server to be degraded, which is designated by the notification 3004, in place of the error DB server.

As a result, the transaction related to the process executed in the DB server designated by the notification 3004 can be aborted.

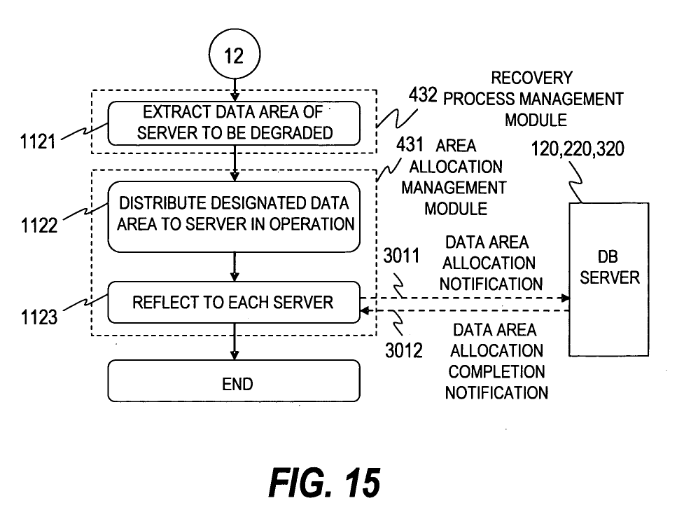

Next, the process shown in FIG. 15 is executed with the process shown in FIG. 10 to follow the above-described processes of FIGS. 14 and 8. The processes 1121 to 1123 of FIG. 15 correspond to the processes 1071 to 1073 shown in FIG. 9 of the first embodiment. A process is performed for the DB server to be degraded, which is designated by the notification 3004, in place of the error DB server. As a result, the data area owned by the DB server designated by the notification 3002 can be allocated to the DB server in operation at another node.

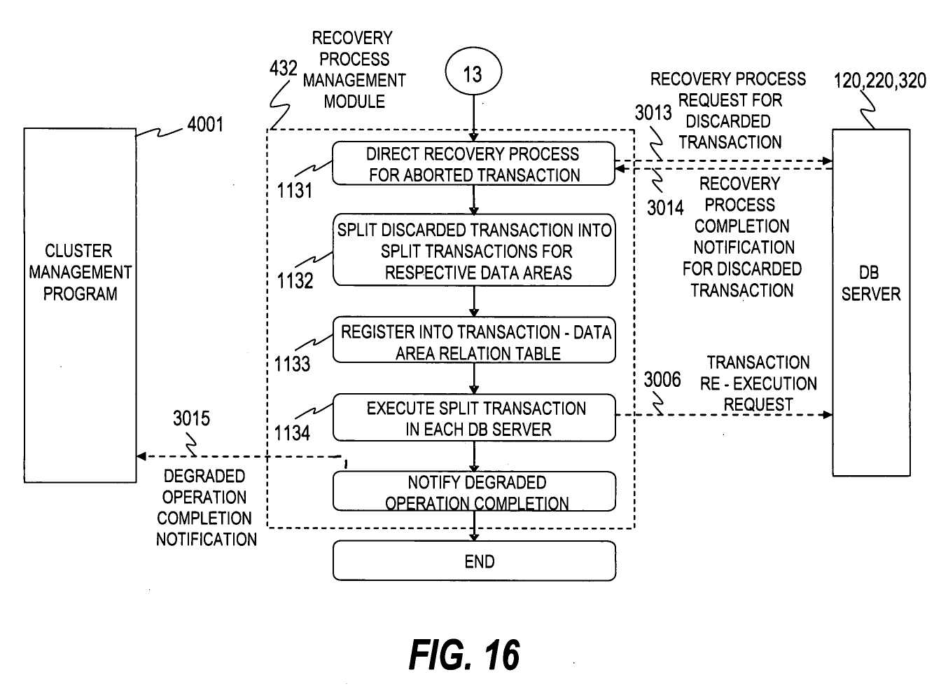

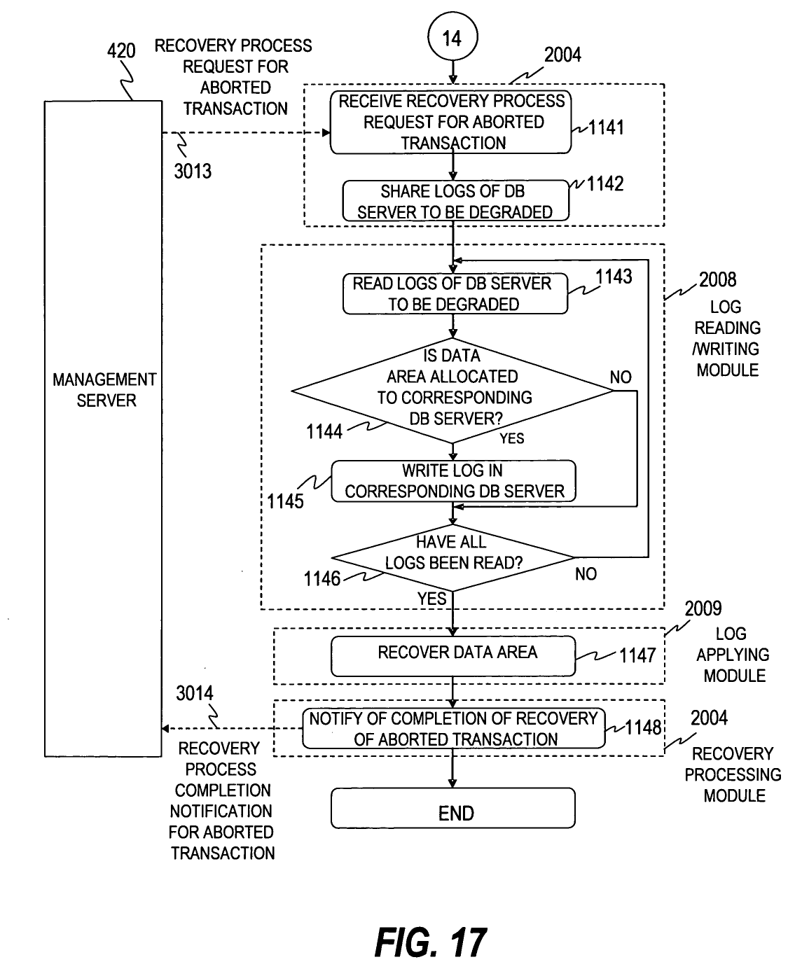

In addition, the process of FIGS. 16 and 17 correspond to those of FIGS. 11 and 12 of this embodiment to follow the processes of FIGS. 14 and 10. Process 1131 shown in FIG. 16 corresponds to the process 1091 shown in FIG. 11, while processes 1141 to 1148 shown in FIG. 17 correspond to the processes 1101 to 1108 shown in FIG. 12. Each of the processes is performed for the DB server to be degraded, which is designated by the notification 3004, in place of the error DB server.

As a result, at the completion of the process 1131, the DB server is degraded. The data area owned by the DB server designated by the notification 3004 is allocated to the DB server in operation. Furthermore, the data area regains the consistency prior to the execution of the transaction extracted in the process 1113. After the process 1131, processes 1132 to 1134 correspond to the processes 1032 to 1034 shown in FIG. 5 of the first embodiment. In place of a transaction from a client, the transaction aborted in the process 1115 is used to perform the process for all the data areas after the change of the allocation by the processes shown in FIGS. 14 and 10. In other words, by the above-described processes 1132 to 1134, the transaction aborted in the process 1115 of FIG. 14 for the degradation is re-executed in a degraded configuration. As a result, the transaction, which was processed in the configuration before the execution of degradation, is processed in the degraded configuration.

As described above, by the processes shown in FIGS. 14 to 17, 8, and 10, the degraded operation for allowing a DB server in operation to take over the data area of a certain DB server can be realized at an arbitrary time point without any loss of the transaction.

Even in the second embodiment, as in the first embodiment, each of the processing modules shown in FIG. 2 may be an independent server to be provided on a different node or may be provided on the same node as the DB nodes. With such a configuration, the configuration as shown in FIG. 13 can be used.

Further, in this second embodiment, the data area in the shared nothing DBMS has been used to calculate the amount of load serving an index of selecting any one of the system failover and the degraded operation. However, other cluster applications allowing the server to perform the system failover and the degraded operation, for example, a WEB application may be used. When this invention is applied to such the cluster application, not the amount of data area that determines the amount of load in the DBMS but the amount of data determining the amount of load on the application may be used. For example, in the case of the WEB application, the amount of connected transactions may be used.

As described above, in the second embodiment, in the shared nothing DBMS having the cluster configuration, based on the direction of degrading a certain node, the process of the DB server on another node, which was executing the transaction related to the process executed in the DB server on the node to be degraded, is aborted. Then, the data area owned by the DB server on the node to be degraded is allocated to the DB server on another node. The log area owned by the DB server to be degraded is shared by the DB server to take over the log area. As a result, the recovery process of the transaction related to the process executed in the node to be degraded can be executed in all the data areas including the data area owned by the DB server to be degraded.

Furthermore, after the completion of the recovery process, the aborted transaction is re-executed in the DBMS having the degraded cluster configuration. As a result, a degraded operation technique, which does not produce any loss of the transaction before and after the degraded operation, can be realized.

By the above operation, in the second embodiment, in the shared nothing DBMS, the degradation to the cluster configuration excluding the node to be degraded can be realized at any arbitrary time point without stopping the processes of all the DB servers. Therefore, a high-availability shared nothing DBMS, which realizes at a high speed the cluster configuration for preventing the deterioration of the DBMS performance caused by the degraded operation, can be provided.

Moreover, according to the first and second embodiments described above, the shared nothing DBMS and the degraded operation using the data area have been described. Any cluster applications allowing the server to perform the system failover and the degraded operation may also be used. Even in such a case, the cluster configuration, which reduces the deterioration of the performance of the application system caused by the degraded operation, can be realized at a high speed. For example, a WEB application can be given as an example of such the application. When this invention is applied to such a cluster application, not the amount of data area that determines the amount of load in the DBMS but the amount of data or a throughput that determines the amount of load on the application may be used. For example, in the case of the WEB application, the amount of connected transactions may be used to realize at a high speed the cluster configuration for preventing the deterioration of the performance of the application system caused by the degraded operation.

Besides the above-described shared nothing DBMS, a shared DBMS may be used as the cluster application allowing the server to perform the system failover and the degraded operation.

As described above, this invention can be applied to a computer system that operates a cluster application allowing a server to perform system failover and a degraded operation. In particular, the application of this invention to a cluster DBMS can improve the availability.

While the present invention has been described in detail and pictorially in the accompanying drawings, the present invention is not limited to such detail but covers various obvious modifications and equivalent arrangements, which fall within the purview of the appended claims.

What is claimed is:

1. A server error recovery method used in a database system comprising: a plurality of servers for dividing a transaction of a database processing for execution; a storage system comprising a preset data area and a preset log area that are accessed by the servers; and a management server for managing the divided transactions allocated to the plurality of servers,
the server error recovery method allowing a normal one of the servers without any error to take over the transaction when an error occurs in any one of the plurality of servers,
the server error recovery method comprising the steps of:
designating a server in which an error occurs, among the plurality of servers;
designating the data area and the log area that are used by the server with the error in the storage system;
aborting a process of another one of the servers executing a transaction related to a process executed in the server with the error;
allocating the data area accessed by the server with the error to another normal one of the servers;
allowing the log area accessed by the server with the error to be shared by the server to which the data area of the server with the error is allocated; and
allowing the server, to which the data area accessed by the server with the error is allocated, to recover the data area based on the shared log area up to a point of the abort of the process.

2. The server error recovery method according to claim 1,
wherein the plurality of servers comprise an active server and a standby server; and
the step of allocating the data area accessed by the server with the error to the another normal server further comprises the steps of:
selecting any one of degradation and the system failover based on a load on the server;
allowing the standby server to take over the active server with the error when the system failover is selected; and
allocating the data area to the normal server to equalize a load on the server to take over the data area of the server with the error when the degradation is selected.

3. The server error recovery method according to claim 2, wherein the step of selecting any one of the degradation and the system failover based on the loads on the servers compares loads to be imposed on the servers when the degradation is selected against loads to be imposed on the servers when the system failover is selected and selects any one of the degradation and the system failover, which provides a smaller variation in load among the servers.

4. A server error recovery method used in a database system comprising: a plurality of servers for dividing a transaction of a database processing for execution; a storage system comprising a preset data area and a preset log area that are accessed by the server; and a management server for managing the divided transactions allocated to the plurality of servers,
the server error recovery method allowing another one of the servers to take over the transaction of the server directed to be degraded,
the server error recovery method comprising the steps of:
designating the server directed to be degraded among the plurality of servers;
designating the data area and the log area that are used by the server to be degraded;
aborting a process of another one of the servers executing a transaction related to a process executed in the server to be degraded;
allocating the data area accessed by the server to be degraded to another one of the servers;
allowing the log area accessed by the server to be degraded to be shared by the server, to which the data area of the server to be degraded is allocated; and
allowing the server, to which the data area accessed by the server to be degraded is allocated, to recover the data area based on the shared log area up to a point of the abort of the process.

5. The server error recovery method according to claim 4, wherein the step of allocating the data area accessed by the server to be degraded to another server allocates the data area to the server to equalize a load on the server taking over the data area of the server to be degraded.

6. A server error recovery method used in a database system comprising: a plurality of servers for dividing a task for execution; a storage system comprising a preset area that is accessed by the servers; and a management server for managing the task to be allocated to the plurality of servers,
the server error recovery method allowing a normal one of the servers without any error to take over the task when an error occurs in any one of the plurality of servers,
the server error recovery method comprising the steps of:
designating the server with the error among the plurality of servers;
designating the data area, used by the server with the error in the storage system;
aborting a process of another one of the servers executing a transaction related to a process executed in the server with the error;
allocating the data area accessed by the server with the error to another normal one of the servers; and
allowing the server, to which the data area accessed by the server with the error is allocated, to recover the data area up to a point of the abort of the process.

7. A database system, comprising:
a plurality of database servers comprising an active database server and a standby database server, connected with each other through a network;
a plurality of data areas for storing data of the database servers;
a plurality of log areas for storing logs of the database servers;
a management server for managing a relation between the database server and the data area and a relation between the database server and the log area; and
a storage system comprising the plurality of data areas and the plurality of log areas being preset,
wherein the management server comprises:
an area allocation management module for allocating the database server accessing the plurality of data areas and log areas;
a transaction control module for distributing the transaction to the plurality of database servers; and
a recovery process management module for performing any one of degradation and the system failover when an error occurs; and
wherein a cluster management module for monitoring the plurality of databases comprises:
an error detecting module for detecting occurrence of an error in the database server;
a recovery process selecting module for selecting any one of degradation and the system failover by obtaining the relation between the database servers and the data areas and the log areas from the management server;
a degradation processing module for transmitting a command of taking over a transaction of the database server with the error to the recovery process management module to equalize a load on the active database server when the degradation is selected; and
a system failover processing module for transmitting a command of causing the standby database server to take over the transaction of the database server with the error when the system failover is selected.

8. The database system according to claim 7, wherein the recovery process management module allocates the data area used by the database server with the error to the normal active database server when the command is issued from the degradation processing module, updates the area allocation management module to cause the log area accessed by the database server with the error to be shared by the active database server, and directs the active database server taking over the transaction to use the log area to recover the data area in which the error occurs.

9. The database system according to claim 7, wherein the recovery process selecting module compares loads on the database servers to be imposed when the degradation is selected against loads to be imposed on the database servers when the system failover is selected, and selects any one of the degradation and the system failover, which provides a smaller variation in load between the database servers.
